(19) United States
(12) Patent Application Publication
(10) Pub. No.: US 2023/0141877 A1
(43) Pub. Date: May 11, 2023

(54) IMAGE DISPLAY METHOD OF DISPLAY DEVICE, IMAGE DISPLAY METHOD OF DISPLAY SYSTEM, AND DISPLAY DEVICE

(71) Applicant: SEIKO EPSON CORPORATION, Tokyo (JP)

(72) Inventor: Soma YAMADA, MATSUMOTO-SHI (JP)

(73) Assignee: SEIKO EPSON CORPORATION, Tokyo (JP)

(21) Appl. No.: 17/982,274

(22) Filed: Nov. 7, 2022

(30) Foreign Application Priority Data
Nov. 8, 2021 (JP) 2021-181874

(51) Int. Cl. G09G 3/00; G09G 5/00

(52) U.S. Cl. CPC G09G 3/001; G09G 5/006; G09G 2370/16

(57) ABSTRACT

There is provided an image display method of a display device, the image display method including displaying a first image based on a first image signal received by wired communication, and starting displaying a second image based on a second image signal received by wireless communication, when detecting that the first image signal by the wired communication is not received.

The present application is based on, and claims priority from JP Application Serial No. 2021-181874, filed Nov. 8, 2021, the disclosure of which is hereby incorporated by reference herein in its entirety.

### BACKGROUND

### 1. Technical Field

The present disclosure relates to an image display method of a display device, an image display method of a display system, and the display device.

### 2. Related Art

There has been known a technique for enabling a display device and an interface device to be attached and detached. For example, a projection system disclosed in JP-A-2006-208832 (Patent Literature 1) includes a projector attachable to and detachable from a pedestal device. The pedestal device includes a tuner that transmits an image signal and a voice signal and a connecting unit that electrically connects the projector and the tuner. The pedestal device transmits the image signal and the voice signal to the projector.

In a configuration in which the display device is attachable and detachable as described in Patent Literature 1, the transmission of the image signal is discontinued by detaching the display device. In this case, since display based on the image signal is interrupted, operation of a user is required in order to resume the display, which is time-consuming.

### SUMMARY

An aspect of the present disclosure is directed to an image display method of a display device, the image display method including: displaying a first image based on a first image signal received by wired communication; and, when detecting a state in which the first image signal by the wired communication cannot be received, starting displaying a second image based on a second image signal received by wireless communication.

Another aspect of the present disclosure is directed to an image display method of a display system, the image display method including: when an interface device is wire-connected to a display device, transmitting a first image signal from the interface device to the display device by wired communication; displaying, with the display device, a first image based on the first image signal received by the wired communication; and, when the display device detects a state in which the first image signal by the wired communication cannot be received, starting displaying a second image based on a second image signal received by wireless communication.

Still another aspect of the present disclosure is directed to a display device including a display unit, the display device executing: displaying a first image based on a first image signal received by wired communication; and, when detecting a state in which the first image signal by the wired communication cannot be received, starting displaying a second image based on a second image signal received by wireless communication.

Still another aspect of the present disclosure is directed to a display system including: a display device including: a display unit; a first connecting unit including a connection terminal and configured to receive a first image signal by wired communication through the connection terminal; a second connecting unit configured to receive a second image signal by wireless communication; and a display control unit; and an interface device including: a signal input unit to which a third image signal is input; a first transmitting unit connected to the connection terminal of the display device and configured to transmit the first image signal by the wired communication through the connection terminal; a second transmitting unit configured to execute wireless communication with the second connecting unit of the display device and transmit the second image signal by the wireless communication; and a transmission control unit. The transmission control unit executes at least one of an operation for transmitting the first image signal from the first transmitting unit based on the third image signal input to the signal input unit and an operation for transmitting the second image signal from the second transmitting unit based on the third image signal input to the signal input unit. The display control unit causes the display unit to display a first image based on the first image signal received by the first connecting unit and, when detecting a state in which the first image signal cannot be received by the first connecting unit, causes the display unit to start displaying a second image based on the second image signal received by the second connecting unit.

### BRIEF DESCRIPTION OF THE DRAWINGS

FIG. 1 is an exterior view of a projector and an interface device.

FIG. 2 is a block diagram showing a configuration example of a control system of a projection system.

FIG. 3 is a sequence chart showing an operation of the projection system.

FIG. 4 is a sequence chart showing an operation of the projection system.

### DESCRIPTION OF EXEMPLARY EMBODIMENTS

### 1. Configurations of a Projector and an Interface Device

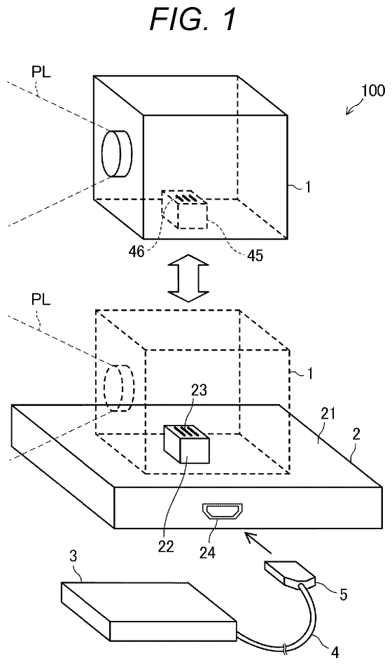

FIG. 1 is an exterior view of a projector 1 and an interface device 2 according to a first embodiment. The projector 1 and the interface device 2 are coupled to each other and configure a projection system 100. The projection system 100 corresponds to an example of the display system.

The projector 1 projects image light PL toward a projection target and forms an image on the projection target. The projector 1 corresponds to an example of the display device. The projector 1 projecting the image light PL is equivalent to displaying an image on the projection target. This operation is referred to as display in the following explanation. The image includes a video and a still image.

The projector 1 is attachable to and detachable from the interface device 2. The projector 1 can display an image in a state in which the projector 1 is coupled to the interface device 2. The projector 1 can display an image in a state in which the projector 1 is separated from the interface device 2.

The interface device 2 is set on the upper surface of a desk or a cabinet. The projector 1 is placed on an upper surface 21 of the interface device 2 in the state in which the projector 1 is coupled to the interface device 2. A protrusion 22 is provided on the upper surface 21. A connection terminal 23 is disposed in the protrusion 22.

A recess 45 is formed on the bottom surface of the projector 1. The recess 45 fits with the protrusion 22 in a state in which the projector 1 is placed on the upper surface 21. The protrusion 22 having a prism shape shown in FIG. 1 is an example. A shape and a size of the protrusion 22 can be optionally changed. A shape and a size of the recess 45 only have to be a shape and a size with which a space capable of housing the protrusion 22 can be formed.

A connection terminal 46 is disposed in the recess 45. The connection terminal 46 is in contact with the connection terminal 23 in a state in which the projector 1 is set on the upper surface 21 of the interface device 2. The connection terminal 23 and the connection terminal 46 are electric contacts made of metal or another conductor. The connection terminal 23 and the connection terminal 46 come into contact with each other to thereby electrically connect the projector 1 and the interface device 2. The projector 1 and the interface device 2 transmit image signals via the connection terminal 23 and the connection terminal 46 as explained below.

An image source 3 is connected to the interface device 2. The image source 3 is a device that outputs an image signal. The image source 3 may be an image output device such as a media player or a digital camera. Examples of the image source 3 include information processing terminals such as a personal computer, a smartphone, and a tablet terminal.

The interface device 2 includes a connector 24. A connector 5 formed at the distal end of a cable 4 for electrically connecting the interface device 2 and the image source 3 can be connected to the connector 24.

The connector 24 and the connector 5 are connectors conforming to a standard concerning image signal transmission. Examples of the standard concerning image signal transmission include HDMI (High-Definition Multimedia Interface), USB (Universal Serial Bus)-Type C, DisplayPort, HDBaseT, and DVI (Digital Visual Interface). However, the standard concerning image signal transmission may be other standards. HDMI, DisplayPort, and HDBaseT are respectively registered trademarks.

The connector 24 and the connector 5 maybe a terminal for inputting and outputting an analog image signal such as an RCA terminal, a VGA terminal, an S terminal, and a D terminal. The interface device 2 may include a plurality of connectors 24. In this case, types and standards of the plurality of connectors 24 may be different.

The interface device 2, the image source 3, and the cable 4 are preferably capable of transmitting and receiving a control signal between the interface device 2 and the image source 3. The control signal is, for example, a signal for the interface device 2 to instruct the image source 3 to temporarily stop and resume an image output. In this embodiment, an example is explained in which the cable 4 is an HDMI cable and the connector 24 and the connector 5 conform to the HDMI standard. In this configuration, the interface device 2 and the image source 3 can transmit and receive the control signal with a CEC (Consumer Electronics Control) link.

### 2. Configuration of a Control System of the Projection System

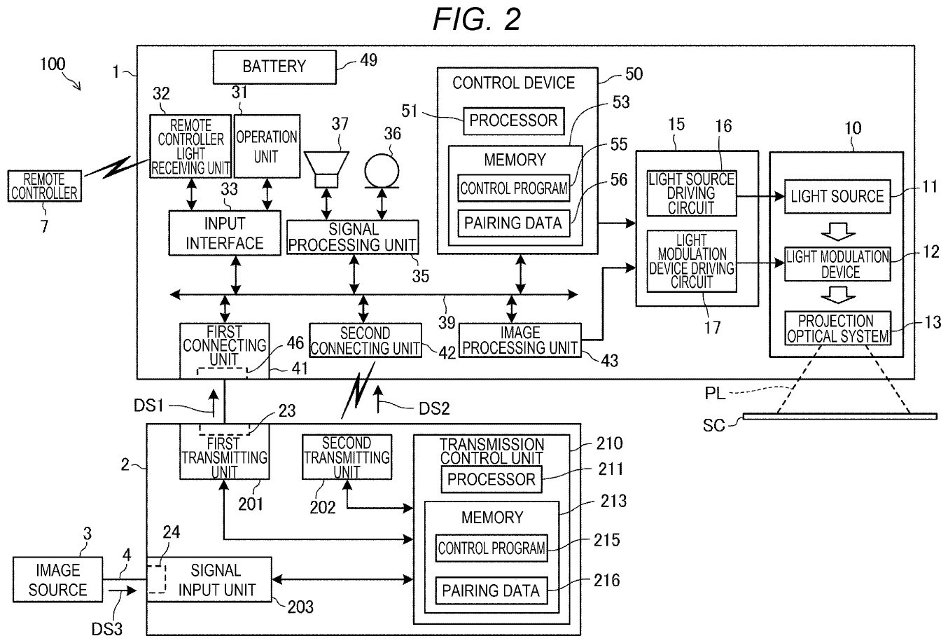

FIG. 2 is a block diagram showing a configuration example of a control system of the projection system 100. As explained above, the projection system 100 includes the projector 1 and the interface device 2. In FIG. 2, a screen SC is shown as a projection target of the projector 1. However, a direction in which the projector 1 projects the image light PL and the projection target are not limited.

The projector 1 includes a projection device 10 that projects the image light PL and a driving circuit 15 that drives the projection device 10. The projection device 10 includes a light source 11, a light modulation device 12, and a projection optical system. 13. The driving circuit 15 includes a light source driving circuit 16 and a light modulation device driving circuit 17.

The light source 11 is a lamp light source such as a halogen lamp, a Xenon lamp, or an ultrahigh-pressure mercury lamp or a solid-state light source such as an LED (light Emitting Diode) or a laser light source. The light source driving circuit 16 lights and extinguishes the light source 11 according to control of a control device 50. The light source driving circuit 16 adjusts luminance of the light source 11 according to the control of the control device 50.

The light modulation device 12 includes a not-shown light modulation element. The light modulation element included in the light modulation device 12 includes, for example, a transmission-type liquid crystal panel. The light modulation element included in the light modulation device 12 may be a reflection-type liquid crystal panel or may be a digital micromirror device (DMD).

Light emitted by the light source 11 is separated into three color lights of red light, green light, and blue light by a not-shown optical element disposed on an optical path between the light source 11 and the light modulation device 12 and is made incident on the light modulation device 12. The light modulation device 12 modulates the lights with the light modulation element to generate image lights PL. The image lights PL are combined by a combination optical system such as a cross dichroic prism and emitted to the projection optical system 13.

The light modulation device driving circuit 17 is connected to an image processing unit 43. The light modulation device driving circuit 17 drives the light modulation device 12 based on an image signal generated by the image processing unit 43 and draws an image on the light modulation element of the light modulation device 12 in frame units.

The projection optical system 13 includes a lens, a mirror, and the like for forming an image of the image light PL on the screen SC. The image light PL is projected onto the screen SC through the projection optical system 13 and causes the screen SC to form a projection image. The screen SC corresponds to an example of a projection surface.

The projector 1 includes an operation unit 31, a remote controller light receiving unit 32, an input interface 33, a signal processing unit 35, a microphone 36, a speaker 37, a first connecting unit 41, a second connecting unit 42, an image processing unit 43, and a control device 50. The input interface 33, the signal processing unit 35, the first connecting unit 41, the second connecting unit 42, the image processing unit 43, and the control device 50 are connected to one another via a bus 39 to be capable of performing data communication.

The operation unit 31 includes various buttons and switches provided on a housing surface of the projector 1. For example, the operation unit 31 includes a switch for instructing a start of a voice recognition function. The operation unit 31 generates an operation signal corresponding to operation of a button or a switch and outputs the operation signal to the input interface 33. The input interface 33 includes a circuit that outputs the operation signal input from the operation unit 31 to the control device 50.

The remote controller light receiving unit 32 includes a light receiving element that receives infrared light. The remote controller light receiving unit 32 receives an infrared signal transmitted from a remote controller 7. When a not-shown switch included in the remote controller 7 is operated, the remote controller 7 transmits an infrared signal indicating the operation. The remote controller light receiving unit 32 decodes the received infrared signal to generate an operation signal. The remote controller light receiving unit 32 outputs the generated operation signal to the input interface 33. The input interface 33 includes a circuit that outputs the operation signal input from the remote controller light receiving unit 32 to the control device 50.

A specific form of signal transmission and reception between the remote controller 7 and the remote controller light receiving unit 32 is not limited. A configuration in which the remote controller 7 transmits the infrared signal to the remote controller light receiving unit 32 is an example. For example, a configuration may be adopted in which the remote controller 7 and the remote controller light receiving unit 32 transmit and receive signals by executing short-range wireless communication such as Bluetooth. In this case, the projector 1 may include, instead of the remote controller light receiving unit 32, a communication processing circuit that executes the short-range wireless communication such as Bluetooth. Bluetooth is a registered trademark.

The signal processing unit 35 is connected to the microphone 36 and the speaker 37. The microphone 36 collects sound on the outside of the housing of the projector 1. The signal processing unit 35 converts voice collected by the microphone 36 into digital voice data and outputs the digital voice data to the control device 50. The signal processing unit 35 drives the speaker 37 based on the digital voice data input from the control device 50 to thereby cause the speaker 37 to output sound.

The signal processing unit 35 may include a digital/analog conversion circuit that converts the digital voice data into an analog voice signal. The signal processing unit 35 may include an amplifier that amplifiers the analog voice signal.

The first connecting unit 41 is an interface device including the connection terminal 46 and an interface circuit that transmits and receives an image signal through the connection terminal 46. In a state in which the connection terminal 23 and the connection terminal 46 are conducting, the first connecting unit 41 receives a first image signal DS1 output by the interface device 2. A signal format of the first image signal DS1 is not limited and may be signal formats conforming to the various standards explained above or may be an unstandardized signal format. The first image signal DS1 may include a voice signal. The first image signal DS1 may include a control signal for controlling the operation of the projector 1 from the interface device 2. The first connecting unit 41 may be capable of transmitting signals such as a control signal to the interface device 2 according to the control of the control device 50.

The second connecting unit 42 is a wireless communication device wirelessly connected to the interface device 2. The second connecting unit 42 includes, for example, an antenna, an RF (Radio Frequency) circuit, and a baseband circuit. The second connecting unit 42 receives a second image signal DS2 from the interface device 2 by wireless communication. The second connecting unit 42 executes, for example, wireless communication conforming to a standard concerning image signal wireless transmission. Examples of the standard concerning image signal wireless transmission include WirelessHD, MIracast, Wi-Fi, and Bluetooth. However, the standard concerning image signal wireless transmission may be other standards. WirelessHD, MIracast, and Wi-Fi are registered trademarks. The second image signal DS2 may include a voice signal. The second image signal DS2 may include a control signal for controlling the operation of the projector 1 from the interface device 2. The second connecting unit 42 may be capable of transmitting signals such as a control signal to the interface device 2 according to the control of the control device 50.

The image processing unit 43 selects an image source according to the control of the control device 50. Sources usable by the projector 1 shown in FIG. 2 are the first image signal DS1 received by the first connecting unit 41, the second image signal DS2 received by the second connecting unit 42, and image data stored in a memory 53. The image processing unit 43 acquires image data from the selected image source and executes image processing on the image data. The image processing executed by the image processing unit 43 is, for example, resolution conversion processing, geometric correction processing, digital zoom processing, and image correction processing for adjusting a tint and luminance of an image. The image processing unit 43 generates an image signal based on the image data after the image processing and outputs the image signal to the light modulation device driving circuit 17. An image displayed by the projector 1 based on the first image signal DS1 corresponds to an example of the first image. An image displayed by the projector 1 based on the second image signal DS2 corresponds to an example of the second image. The first image and the second image may be the same image. That is, the first image signal DS1 and the second image signal DS2 may be signals for transmitting the same image through different transmission paths.

A not-shown frame memory may be connected to the image processing unit 43. The frame memory is configured by, for example, an SDRAM (Synchronous Dynamic Random Access Memory). In this case, the image processing unit 43 loads image data acquired from a source in the frame memory. The image processing unit 43 executes the image processing on the image data loaded in the frame memory.

The image processing unit 43 can be configured by, for example, an integrated circuit. The integrated circuit is configured by, for example, an LSI (Large Scale Integration). More specifically, the image processing unit 43 is configured by an ASIC (Application Specific Integrated Circuit), a PLD (Programmable Logic Device), or the like. For example, an FPGA (Field-Programmable Gate Array) is included in the PLD. An analog circuit may be included in a part of the configuration of the integrated circuit. A processor and the integrated circuit may be combined. The combination of the processor and the integrated circuit is called microcontroller (MCU), SoC (System-on-a-Chip), system LSI, chipset, and the like.

The projector 1 includes a battery 49. The battery 49 incorporates a secondary battery such as a lithium ion battery or a metal-hydrogen battery and supplies electric power of the secondary battery to the units of the projector 1. The projector 1 includes a not-shown charging connector and charges the battery 49 with electric power input to the charging connector from the outside. The projector 1 can cause the units including the projection device 10, the driving circuit 15, the second connecting unit 42, the image processing unit 43, and the control device 50 to operate with electric power of the battery 49. Specifically, the projector 1 can project the image light PL with the electric power charged in the battery 49. The charging connector may be provided in the first connecting unit 41. For example, a terminal in a part of the connection terminal 46 is a power feed terminal that supplies electric power from the interface device 2 to the projector 1. The battery 49 may be charged by the electric power supplied by the connection terminal 46.

The control device 50 includes a processor 51 and a memory 53. The memory 53 is a storage device that stores, in a nonvolatile manner, programs to be executed by the processor 51 and data. The memory 53 is configured by a magnetic storage device, a semiconductor storage element such as a flash ROM (Read Only Memory), or a nonvolatile storage device of another type. The memory 53 may include a RAM (Random Access Memory) configuring a work area of the processor 51. The memory 53 stores data to be processed by the control device 50 and a control program 55 to be executed by the processor 51.

The processor 51 is configured by a CPU (Central Processing Unit) or an MPU (Micro-processing unit). The processor 51 may be configured as a single processor. A plurality of processors may function as the processor 51. The processor 51 maybe configured by an SoC integrated with a part or the entire memory 53 and/or other circuits. As explained above, the processor 51 may be configured by a combination of a CPU that executes a program and a DSP (Digital Signal Processor) that executes predetermined arithmetic processing. All of functions of the processor 51 may be implemented in hardware or may be configured using a programmable device. The processor 51 may also have functions of the image processing unit 43. That is, the processor 51 may execute the functions of the image processing unit 43.

The processor 51 executes the control program 55 stored by the memory 53 to thereby control the units of the projector 1. The control device 50 corresponds to an example of the display control unit.

The processor 51 causes the image processing unit 43 to select a source and acquire image data of the selected source. The processor 51 controls the driving circuit 15 and causes the projection device 10 to project the image light PL based on an image signal output by the image processing unit 43 and display an image.

The memory 53 stores, for example, image data. When the image processing unit 43 selects the image data stored by the memory 53 as a source, an image based on the image data stored by the memory 53 is projected by the projection device 10.

When the connection terminal 23 of the interface device 2 is electrically connected to the first connecting unit 41 of the projector 1, the processor 51 causes the first connecting unit 41 to receive the first image signal DS1 by wired communication. In a state in which the interface device 2 and the first connecting unit 41 are wire-connected, the processor 51 monitors disconnection of the wire connection of the interface device 2 and the first connecting unit 41. The state in which the interface device 2 and the first connecting unit 41 are wire-connected corresponds to a state in which the first image signal can be received. When detecting that the wire connection of the interface device 2 and the first connecting unit 41 is disconnected, the processor 51 attempts connection to the interface device 2 with the second connecting unit 42. A state in which the wire connection of the interface device 2 and the first connecting unit 41 is disconnected corresponds to a state in which the first image signal cannot be received. When the second connecting unit 42 and the interface device 2 are wirelessly connected, the processor 51 receives the second image signal DS2 by wireless communication.

A specific operation for detecting disconnection of the wire connection of the interface device 2 and the first connecting unit 41 is not limited. The processor 51 only has to be able to detect that the first image signal DS1 cannot be received from the interface device 2. Specific examples 1 to 4 of a configuration in which the processor 51 detects disconnection of the wire connection are explained below.

Specific example 1: When the first image signal DS1 received by the first connecting unit 41 is interrupted, the processor 51 detects that the wire connection is disconnected. Specifically, when an electric signal input to the connection terminal 46 of the first connecting unit 41 stops and a stop time exceeds a predetermined time and times out, the processor 51 detects that the wire connection is disconnected.

Specific example 2: The processor 51 monitors electric conduction of the connection terminal 23 and the connection terminal 46. When detecting that the conduction is interrupted, the processor 51 detects that the wire connection is disconnected. When this method is adopted, if contacts for conduction check are provided in the connection terminal 23 and the connection terminal 46, the processor 51 can more easily detect disconnection of the wire connection.

Specific example 3: In a configuration in which electric power is supplied from the connection terminal 23 to the first connecting unit 41, by detecting that the power supply to the first connecting unit 41 is interrupted, the processor 51 detects that the wire connection is disconnected. This operation is useful in a configuration in which the battery 49 is charged by electric power input to the first connecting unit 41 as explained above.

Specific example 4: The projection system 100 includes a component that detects physical separation of the protrusion 22 of the interface device 2 and the recess 45 of the projector 1. Specifically, the projector 1 includes, on the inside of the recess 45, a sensor that detects fitting with the protrusion 22. The sensor is, for example, a switch-type sensor that comes into contact with the protrusion 22 and operates or an optical or magnetic sensor that detects approach of the protrusion 22. When detecting, based on a detection value of the sensor, that the protrusion 22 separates from the recess 45, the processor 51 detects disconnection of the wire connection.

When detecting that the interface device 2 is wire-connected to the first connecting unit 41, the processor 51 may start an operation for receiving, with the first connecting unit 41, the first image signal DS1 from the interface device 2 by wired communication. For example, the processor 51 executes the operation in a state in which the interface device 2 is wirelessly connected to the second connecting unit 42 and the interface device 2 is not connected to the first connecting unit 41. In this operation, the processor 51 attempts wired communication between the first connecting unit 41 and the interface device 2. When the wired communication is established, the processor 51 starts receiving the first image signal DS 1 by the wired communication. Further, the processor 51 may disconnect the wireless connection of the second connecting unit 42 and the interface device 2.

The interface device 2 includes a first transmitting unit 201, a second transmitting unit 202, a signal input unit 203, and a transmission control unit 210.

The first transmitting unit 201 is an interface device including the connection terminal 23 and an interface circuit that transmits and receives an image signal through the connection terminal 23. The first transmitting unit 201 transmits the first image signal DS1 to the projector 1 in a state in which the connection terminal 23 and the connection terminal 46 are conducting.

The second transmitting unit 202 is a wireless communication device wirelessly connected to the projector 1. The second transmitting unit 202 includes, for example, an antenna, an RF circuit, and a baseband circuit. The second transmitting unit 202 is wirelessly connected to the second connecting unit 42 by wireless communication and wirelessly transmits the second image signal DS2 to the projector 1. The second transmitting unit 202 only has to be configured to be capable of communicating with the second connecting unit 42 and executes, for example, wireless communication conforming to the various standards explained above concerning wireless transmission of an image signal.

The signal input unit 203 is an interface device including the connector 24 and an interface circuit that receives an image signal through the connector 24. The signal input unit 203 receives, with the connector 24, a third image signal DS3 output by the image source 3 through the cable 4. A signal format of the third image signal DS3 is not limited and may be a signal format conforming to the various standards explained above or may be an unstandardized signal format. The third image signal DS3 may include a voice signal. The third image signal DS3 may be capable of transmitting and receiving a control signal for controlling an operation between the interface device 2 and the image source 3. In this embodiment, the cable 4 is an HDMI cable and the third image signal DS3 is a signal conforming to a HDMI format. The image source 3 transmits the third image signal DS3 including a video and voice of the HDMI format to the interface device 2. The signal input unit 203 transmits a control signal to the image source 3 according to control of the transmission control unit 210. The control signal is, for example, a CEC command.

The transmission control unit 210 is connected to each of the first transmitting unit 201, the second transmitting unit 202, and the signal input unit 203.

The transmission control unit 210 includes a processor 211 and a memory 213. The memory 213 is a storage device that stores programs to be executed by the processor 211 and data in a nonvolatile manner. The memory 213 is configured by a magnetic storage device, a semiconductor storage element such as a flash ROM, or a nonvolatile storage device of another type. The memory 213 may include a RAM configuring a work area of the processor 211. The memory 213 stores data to be processed by the transmission control unit 210 and a control program 215 to be executed by the processor 211.

The processor 211 is configured by a CPU, an MPU, a microcomputer, or the like. The processor 211 may be configured by a single processor or a plurality of processors may be configured to function as the processor 211. The processor 211 may be configured by an SoC integrated with a part or the entire memory 213 and/or other circuits. All of functions of the processor 211 may be implemented in hardware or may be configured using a programmable device.

The processor 211 executes the control program 215 stored by the memory 213 to thereby control the units of the interface device 2.

The processor 211 receives the third image signal DS3 with the signal input unit 203 and generates the first image signal DS1 or the second image signal DS2 based on the third image signal DS3. The first image signal DS1 and the second image signal DS2 may be the same signal as the third image signal DS3. This operation is effective in, for example, a configuration in which the first transmitting unit 201, the second transmitting unit 202, and the signal input unit 203 are adaptable to a common signal format. Examples of the configuration include a configuration in which all of the first transmitting unit 201, the second transmitting unit 202, and the signal input unit 203 conform to the HDMI standard.

The processor 211 may generate the first image signal DS1 and the second image signal DS2 by converting a frame frequency, resolution, and transmission speed of the third image signal DS3. The processor 211 may perform processing for generating image data from an image signal included in the third image signal DS3 and generating the first image signal DS1 and the second image signal DS2 anew based on the generated image data. In this case, the processor 211 may perform the same processing for a voice signal included in the third image signal DS3. The processing is effective, for example, when the first transmitting unit 201 and the second transmitting unit 202 conform to a standard different from a standard of the signal input unit 203 or when an unstandardized signal format is adopted.

When the connection terminal 23 is wire-connected to the connection terminal 46, the processor 211 controls the first transmitting unit 201 to connect the first connecting unit 41 of the projector 1 and the first transmitting unit 201. The processor 211 controls the first transmitting unit 201 to output the first image signal DS1 to the projector 1 from the first transmitting unit 201.

The processor 211 monitors disconnection of the wire connection of the first transmitting unit 201 and the projector 1 in a state in which the first transmitting unit 201 and the first connecting unit 41 are wire-connected. When detecting that the wire connection of the first transmitting unit 201 and the projector 1 is disconnected, the processor 211 attempts connection to the projector 1 with the second transmitting unit 202. When the second transmitting unit 202 and the projector 1 are wirelessly connected, the processor 211 transmits the second image signal DS2 from the second transmitting unit 202 to the projector 1 by wireless communication.

A specific operation in which the processor 211 detects that the wire connection of the first transmitting unit 201 and the projector 1 is disconnected is not limited. The processor 211 only has to be able to detect a state in which the first image signal DS1 cannot be transmitted. Specific examples of a configuration in which the processor 211 detects disconnection of the wire connection are explained. Specific examples 1 to 4 explained below respectively correspond to the specific examples 1 to 4 of the operation of the processor 51 explained above.

Specific example 1: When the first image signal DS1 transmitted by the first transmitting unit 201 is interrupted, the processor 211 detects that the wire connection is disconnected. The first connecting unit 41 of the projector 1 transmits a response to the transmitting unit 201 at a frame period, a packet period, or other timing while the first transmitting unit 201 transmits the first image signal DS1. The processor 211 detects that the wire connection is disconnected when an electric signal input to the connection terminal 23 from the projector 1 stops and a stop time exceeds a predetermined time and times out.

Specific example 2: The processor 211 monitors electric conduction of the connection terminal 23 and the connection terminal 46. When detecting that the conduction is interrupted, the processor 211 detects that the wire connection is disconnected. When this method is adopted, for example, if contacts for conduction check are provided in the connection terminal 23 and the connection terminal 46, the processor 211 can more easily detect disconnection of the wire connection.

Specific example 3: In the configuration in which electric power is supplied from the connection terminal 23 to the first connecting unit 41, by detecting a state in which the electric power supply to the first connecting unit 41 cannot be performed, the processor 211 detects that the wire connection is disconnected. For example, when detecting that a state of a load connected to the connection terminal 23 of the first transmitting unit 201 suddenly changes or a load is not connected to the connection terminal 23, the processor 211 detects disconnection of the wire connection. This operation is effective in the configuration in which the first transmitting unit 201 supplies electric power for charging the battery 49 to the first connecting unit 41 as explained above.

Specific example 4: The projection system 100 includes a component that detects physical separation of the protrusion 22 of the interface device 2 and the recess 45 of the projector 1. Specifically, the projection system 100 includes, in the protrusion 22, a sensor that detects fitting with the surface of the recess 45. The sensor is, for example, a switch-type sensor that comes into contact with the surface of the recess 45 and operates or an optical or magnetic sensor that detects approach of the recess 45. When detecting based on a detection value of the sensor that the protrusion 22 separates from the recess 45, the processor 211 detects disconnection of the wire connection.

The processor 211 may execute the operation corresponding to the wire connection of the projector 1 in a state in which the projector 1 is wirelessly connected to the second transmitting unit 202 and the projector 1 is not wire-connected to the first transmitting unit 201. Specifically, when detecting that the projector 1 is wire-connected to the first transmitting unit 201, the processor 211 may start an operation for transmitting the first image signal DS1 from the first transmitting unit 201 by wired communication. In this operation, the processor 211 attempts wired communication between the first transmitting unit 201 and the projector 1 and, when the wired communication is established, starts transmitting the first image signal DS1 by the wired communication. Further, the processor 211 may disconnect the wireless connection of the second transmitting unit 202 and the projector 1.

A subject of an operation in the case in which the processor 211 starts, with the first transmitting unit 201, wired communication with the projector 1 and an operation in the case in which the processor 211 is wirelessly connected to the interface device 2 by the second transmitting unit 202 is not limited. For example, in processing in which the projector 1 and the interface device 2 establish communication, the processor 51 may take the initiative in executing an operation and the processor 211 may operate according to control of the processor 51 or the processor 51 and the processor 211 may operate oppositely to this. The processor 51 and the processor 211 may respectively autonomously execute operations.

The memory 53 included in the projector 1 stores pairing data 56. The pairing data 56 is identification information capable of identifying an individual interface device 2. The pairing data 56 includes at least one of identification information of the interface device 2 connected by the first connecting unit 41 and identification information of the interface device 2 connected by the second connecting unit 42. The pairing data 56 is generated according to operation of the remote controller 7 or the operation unit 31 in a state in which the interface device 2 is connected to the first connecting unit 41 or the second connecting unit 42.

When the interface device 2 is wire-connected to the first connecting unit 41, the processor 51 authenticates the interface device 2 based on whether identification information of the connected interface device 2 is included in the pairing data 56. When the identification information of the interface device 2 connected to the first connecting unit 41 is included in the pairing data 56, the processor 51 establishes wired communication with the interface device 2. By establishing the wired communication, the processor 51 is capable of executing reception of the first image signal DS1.

When identification information of the interface device 2 to which wireless connection is attempted by the second connecting unit 42 is included in the pairing data 56, the processor 51 establishes wireless communication between the second connecting unit 42 and the interface device 2.

By using the pairing data 56 in this way, it is possible to limit an operation in the case in which the projector 1 is coupled to an unknown interface device 2 and wireless connection to the unknown interface device 2.

The memory 213 included in the interface device 2 stores pairing data 216. The pairing data 216 is identification information capable of identifying an individual projector 1. The pairing data 216 includes at least one of identification information of the projector 1 connected by the first transmitting unit 201 and identification information of the projector 1 connected by the second transmitting unit 202. The pairing data 216 is generated according to operation of the remote controller 7 or the operation unit 31 in a state in which the projector 1 is connected to the first transmitting unit 201 or the second transmitting unit 202.

When the projector 1 is wire-connected to the first transmitting unit 201, the processor 211 authenticates the projector 1 based on whether identification information of the connected projector 1 is included in the pairing data 216. The processor 211 establishes wired communication with the projector 1 when the identification information of the projector 1 connected to the first transmitting unit 201 is included in the pairing data 216. By establishing the wired communication, the processor 211 is capable of executing transmission of the first image signal DS1.

The processor 211 establishes wireless connection by the second transmitting unit 202 when identification information of the projector 1 to which the wireless connection is attempted by the second transmitting unit 202 is included in the pairing data 216. Consequently, it is possible to limit an operation in the case in which an unknown projector 1 is coupled to the interface device 2 and wireless connection to the unknown projector 1.

### 3. Operation of the Projection System

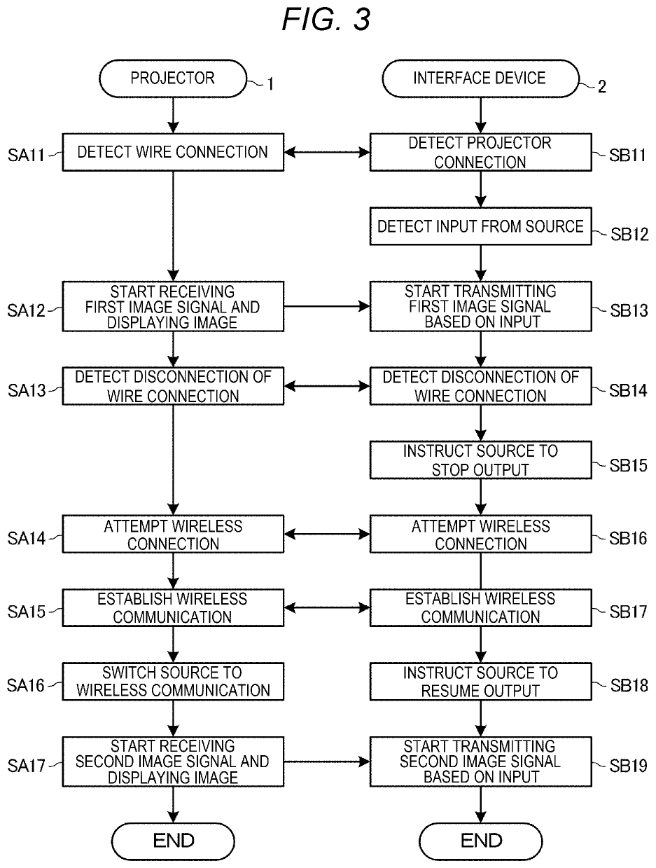

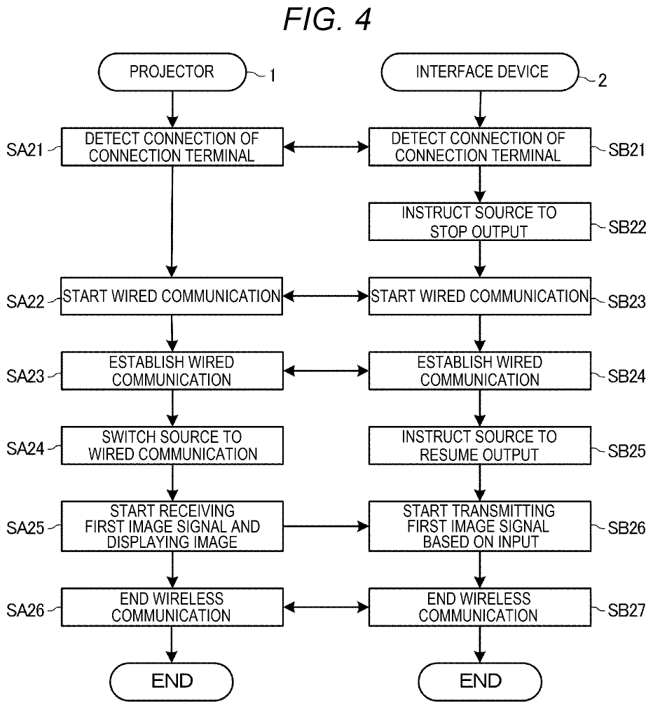

FIGS. 3 and 4 are sequence charts showing an operation of the projection system 100.

FIG. 3 shows an operation in the case in which one or both of the projector 1 and the interface device 2 are turned on in a state in which the projector 1 is coupled to the interface device 2. Steps SA11 to SA17 in FIG. 3 indicate an operation of the projector 1 and are executed by the control device 50. Steps SB11 to SB19 indicate an operation of the interface device 2 and are executed by the transmission control unit 210.

In step SA11, the projector 1 detects that the interface device 2 is wire-connected to the first connecting unit 41. In step SB11, the interface device 2 detects that the first transmitting unit 201 is connected to the projector 1. At this time, the projector 1 and the interface device 2 are capable of executing wired communication according to steps SA11 and SB11.

In step SA11, the projector 1 may execute, using the pairing data 56, authentication for the interface device 2 connected to the first connecting unit 41. The projector 1 may be configured to start wired communication with the interface device 2 when succeeding in the authentication. Similarly, in step SB11, the interface device 2 may execute, using the pairing data 216, authentication for the projector 1 connected to the first transmitting unit 201. The interface device 2 may be configured to start wired communication with the projector 1 when succeeding in the authentication.

When detecting in step SB12 that the third image signal DS3 is input to the connector 24 from the image source 3, the interface device 2 shifts to step SB13. In step SB13, the interface device 2 starts, based on the third image signal DS3, transmitting the first image signal DS1 by wired communication.

In step SA12, the projector 1 starts processing for receiving, by wired communication, the first image signal DS1 transmitted by the interface device 2 and processing for displaying an image with the projection device 10 based on the received first image signal DS1.

After steps SA12 and SB13, the projection system. 100 executes an operation for displaying, with the projector 1, an image of the third image signal DS3 input to the interface device 2 from the image source 3.

In the following explanation, for example, operation for detaching the projector 1 from the interface device 2 is performed and the wire connection of the projector 1 and the interface device 2 is disconnected.

In step SA13, the projector 1 detects disconnection of the wire connection. In step SB14, the interface device 2 detects disconnection of the wire connection. Details of the operations in steps SA13 and SB14 are as explained above.

The interface device 2 shifts to step SB15 and transmits a control signal to the image source 3 from the signal input unit 203. The control signal transmitted in step SB15 is a signal for instructing to stop the output of the third image signal DS3 and is, for example, a CEC command for instructing a temporary stop of an image output or image reproduction.

In step SA14, the projector 1 attempts wireless connection by the second connecting unit 42. In step SB16, the interface device 2 attempts wireless connection by the second transmitting unit 202. When succeeding in mutual communication between the projector 1 and the interface device 2, the projector 1 establishes wireless communication in step SA15 and the interface device 2 establishes wireless communication in step SB17.

Instep SA14, the projector 1 may execute, using the pairing data 56, authentication for equipment to which wireless connection is attempted. The projector 1 may be configured to establish wireless communication by the second connecting unit 42 when succeeding in the authentication. In step SB16, the interface device 2 may execute, using the pairing data 216, authentication for equipment to which wireless connection is attempted. The interface device 2 may be configured to establish wireless communication by the second transmitting unit 202 when succeeding in the authentication.

When the wireless communication by the second connecting unit 42 is established, in step SA16, the projector 1 switches a source selected by the image processing unit 43 to the second connecting unit 42.

When the wireless communication by the second transmitting unit 202 is established, in step SB18, the interface device 2 transmits a control signal to the image source 3. The control signal transmitted in step SB18 is a signal for instructing to resume the output of the third image signal DS3 and is, for example, a CEC command for instructing resumption of the image output or the image reproduction.

Thereafter, when detecting in step SB18 that the third image signal DS3 is input to the connector 24 from the image source 3, the interface device 2 shifts to step SB19. In step SB19, the interface device 2 starts, based on the third image signal DS3, transmitting the second image signal DS2 by wireless communication.

In step SA17, the projector 1 starts processing for receiving, by wireless communication, the second image signal DS2 transmitted by the interface device 2 and processing for displaying an image with the projection device 10 based on the received second image signal DS2.

FIG. 4 shows an operation in the case in which the projector 1 is coupled to the interface device 2 in a state in which the projector 1 is detached from the interface device 2 and the second image signal DS2 is transmitted from the interface device 2 to the projector 1 by wireless communication. Steps SA21 to SA26 in FIG. 4 indicate an operation of the projector 1 and are executed by the control device 50. Steps SB21 to SB27 indicate an operation of the interface device 2 and are executed by the transmission control unit 210.

In step SA21, the projector 1 detects that the interface device 2 is connected to the connection terminal 46 of the first connecting unit 41. The projector 1 shifts to step SA22 and starts wired communication with the interface device 2.

In step SB21, the interface device 2 detects that the projector 1 is connected to the connection terminal 23 of the first transmitting unit 201. The interface device 2 shifts to step SB22 and transmits a control signal to the image source 3 from the signal input unit 203. The control signal transmitted in step SB22 is a signal for instructing to stop the output of the third image signal DS3 and is, for example, a CEC command for instructing a temporary stop of an image output or image reproduction. The interface device 2 shifts to step SB23 and starts wired communication with the projector 1.

In step SA23, the projector 1 may execute, using the pairing data 56, authentication for the interface device 2 connected to the first connecting unit 41. The projector 1 maybe configured to establish wired communication by the first connecting unit 41 when succeeding in the authentication. In step SB24, the interface device 2 may execute, using the pairing data 216, authentication for the projector 1 connected to the first transmitting unit 201. The interface device 2 may be configured to establish wired communication by the first transmitting unit 201 when succeeding in the authentication.

After establishing the wired communication, instep SA24, the projector 1 switches a source selected by the image processing unit 43 to the first image signal DS1 received by the first connecting unit 41.

After establishing the wired communication, instep SB25, the interface device 2 transmits a control signal to the image source 3. The control signal transmitted in step SB25 is a signal for instructing to resume the output of the third image signal DS3 and is, for example, a CEC command for instructing resumption of the image output or the image reproduction.

When detecting that the third image signal DS3 is input to the connector 24 from the image source 3, the interface device 2 shifts to step SB26. In step SB26, the interface device 2 starts, based on the third image signal DS3, transmitting the first image signal DS1 by wired communication.

In step SA25, the projector 1 starts processing for receiving, by wired communication, the first image signal DS1 transmitted by the interface device 2 and processing for displaying an image with the projection device 10 based on the received first image signal DS1.

In step SA26, the projector 1 ends the wireless communication with the interface device 2 by the second connecting unit 42. In step SB27, the interface device 2 ends the wireless communication with the projector 1 by the second transmitting unit 202. In steps SA26 and SB27, the wireless connection of the projector 1 and the interface device 2 is disconnected.

The projector 1 and the interface device 2 may maintain the wireless connection even after the transmission of the second image signal DS2 from the interface device 2 to the projector 1 is started. In this case, there is an advantage that the operations in steps SA14 and SA15 and SB16 and SB17 in FIG. 3 are quickly performed when the wired connection of the projector 1 and the interface device 2 is disconnected. In this case, the projector 1 and the interface device 2 preferably stop the transmission and reception of the second image signal DS2 without disconnecting the wireless communication.

### 4. Action in the Embodiment

As explained above, the image display method of the projector 1 explained in the embodiment includes displaying the first image based on the first image signal DS1 received by wired communication. The image display method of the projector 1 includes, when detecting a state in which the first image signal DS1 by the wired communication cannot be received, starting displaying the second image based on the second image signal DS2 received by wireless communication.

Consequently, when the projector 1 becomes unable to receive the first image signal DS1, it is possible to start receiving the second image signal DS2 and display an image with the projection device 10. Accordingly, when the first image signal DS1 is interrupted, it is possible to continue the display even if the user does not perform operation.

The image display method of the projector 1 may be a method of, when it becomes possible to receive the first image signal DS1 by the wired communication while the second image is displayed, finishing displaying the second image and starting displaying the first image. In this case, the first image signal DS1 is started to be received and an image based on the first image signal DS1 is started to be displayed while the second image signal DS2 is received and the image is displayed by the projection device 10. Consequently, since the wired communication is used when the image can be transmitted by the wired communication, it is possible to receive an image signal in a communication path having higher stability.

The image display method of the projection system 100 includes, when the interface device 2 is wire-connected to the projector 1, transmitting the first image signal DS1 from the interface device 2 to the projector 1 by wired communication. The image display method of the projection system 100 includes displaying, with the projector 1, the first image based on the first image signal DS1 received by the wired communication. The image display method of the projection system 100 includes, when the projector 1 detects a state in which the first image signal DS1 by the wired communication cannot be received, starting displaying the second image based on the second image signal DS2 received by wireless communication.

Consequently, when the projector 1 becomes unable to receive the first image signal DS1 from the interface device 2 by wired communication, it is possible to receive the second image signal DS2 by wireless communication and display an image. Accordingly, when the first image signal DS1 is interrupted, it is possible to continue the display even if the user does not perform operation.

The image display method of the projection system 100 may include transmitting the second image signal DS2 from the interface device 2 to the projector 1 by wireless communication. In this case, when the first image signal DS1 is interrupted, it is possible to continue transmitting an image from the interface device 2 to the projector 1.

The image display method of the projection system 100 may include receiving the third image signal DS3 with the interface device 2. The transmitting the first image signal DS1 from the interface device 2 to the projector 1 by wired communication may include transmitting the first image signal DS1 with the interface device 2 based on the third image signal DS3. The transmitting the second image signal DS2 from the interface device 2 to the projector 1 by wireless communication may include transmitting the second image signal DS2 with the interface device 2 based on the third image signal DS3.

In this case, the interface device 2 transmits the first image signal DS1 and the second image signal DS2 to the projector 1 based on the third image signal DS3. Accordingly, even if the first image signal DS1 is interrupted while an image based on the first image signal DS1 is displayed, it is possible to continue to display an image based on the third image signal DS3 by receiving the second image signal DS2.

The projector 1 disclosed in the embodiment includes the projection device 10 and executes displaying the first image based on the first image signal DS1 received by wired communication. When detecting a state in which the first image signal DS1 by the wired communication cannot be received, the projector 1 executes starting displaying the second image based on the second image signal DS2 received by wireless communication.

Consequently, when the projector 1 becomes unable to receive the first image signal DS1 from the interface device 2 by wired communication, it is possible to receive the second image signal DS2 by wireless communication and display an image. Accordingly, when the first image signal DS1 is interrupted, it is possible to continue the display even if the user does not perform operation.

The projection system 100 includes the projector 1 and the interface device 2. The projector 1 includes the projection device 10 and the first connecting unit 41 that includes the connection terminal 46 and receives the first image signal DS1 by wired communication through the connection terminal 46. The projector 1 includes the second connecting unit 42 that receives the second image signal DS2 by wireless communication and the control device 50. The interface device 2 includes the signal input unit 203 to which the third image signal DS3 is input and the first transmitting unit 201 that is connected to the connection terminal 46 of the projector 1 and transmits the first image signal DS1 by wired communication through the connection terminal 46. The interface device 2 includes the second transmitting unit 202 that is wirelessly connected to the second connecting unit 42 of the projector 1 and transmits the second image signal DS2 by wireless communication and the transmission control unit 210. The transmission control unit 210 executes at least one of an operation for transmitting the first image signal DS1 from the first transmitting unit 201 based on the third image signal DS3 and an operation for transmitting the second image signal DS2 from the second transmitting unit 202 based on the third image signal DS3. The control device 50 displays, on the projection device 10, the first image based on the first image signal DS1 received by the first connecting unit 41. When detecting a state in which the first image signal DS1 cannot be received by the first connecting unit 41, the control device 50 causes the projection device 10 to start displaying the second image based on the second image signal DS2 received by the second connecting unit 42.

Consequently, the projector 1 that displays an image with the projection device 10 can receive the first image signal DS1 from the interface device 2 by wired communication and display an image based on the first image signal DS1. When the projector 1 becomes unable to receive the first image signal DS1, the projector 1 can receive the second image signal DS2 by wireless communication and display an image based on the second image signal DS2. Accordingly, when the first image signal DS1 is interrupted, it is possible to continue the display even if the user does not perform operation.

In the projection system 100, when the projector 1 becomes unable to receive the first image signal DS1 with the first connecting unit 41, the transmission control unit 210 causes the signal input unit 203 to output an instruction to stop transmitting the third image signal DS3. For example, the interface device 2 transmits a CEC command from the signal input unit 203 to the image source 3. Consequently, it is possible to stop an input of the third image signal DS3 after the projector 1 becomes unable to receive the first image signal DS1 with the first connecting unit 41. That is, it is possible to stop an advance of the third image signal DS3 in a state in which the projector 1 cannot perform display. Accordingly, it is possible to prevent display content from advancing before the projector 1 can start display.

### 5. Other Embodiments

The embodiment explained above is a preferred implementation mode of the present disclosure. However, the present disclosure is not limited to this and various modified implementations are possible within a range not departing from the gist of the present disclosure.

For example, in the embodiment, the configuration is illustrated in which the projector 1 and the interface device 2 are electrically connected by placing the projector 1 on the interface device 2. In this configuration, by lifting the projector 1 from the interface device 2, the projector 1 and the interface device 2 are uncoupled and the electric connection is disconnected. This configuration is an example. For example, the projector 1 and the interface device 2 may be electrically connected via a cable. In this case, by detaching the cable from the projector 1 or the interface device 2, the electric connection, that is, wire connection of the projector 1 and the interface device 2 is disconnected. In this case as well, the operations shown in FIGS. 3 and 4 can be applied.

For example, a relay device that amplifies and distributes an image signal may be interposed between the projector 1 and the interface device 2. In this case, the projector 1 and the interface device 2 are electrically connected via the relay device. Specifically, the projector 1 and the relay device are electrically connected by a cable and a terminal. The interface device 2 and the relay device are electrically connected by a cable and a terminal. In this case, by detaching the cable that connects the projector 1 and the relay device or the cable that connects the interface device 2 and the relay device, the electric connection, that is, the wire connection of the projector 1 and the interface device 2 is disconnected. In this case as well, the operations shown in FIGS. 3 and 4 can be applied.

In the embodiment, the projection system 100 that uses the projector 1 as the display device is explained as an example. However, the display system is not limited to the configuration including the projector 1 that functions as the display device and projects an image on the screen SC. For example, the display device may be a liquid crystal display including a liquid crystal display panel. The display device may be, for example, a display including a PDP (plasma display panel) or an organic EL (Electro-Luminescence) panel. The present disclosure can be applied to other various display devices. In this case, the liquid crystal display panel, the PDP, and the organic EL panel correspond to examples of the display unit.

The configuration of the projector 1 and the interface device 2 shown in FIG. 2 indicates a functional configuration. A specific implementation form is not particularly limited. That is, hardware individually corresponding to the functional units does not always need to be implemented. It is also naturally possible to adopt a configuration in which one processor executes a program to realize functions of a plurality of functional units. A part of functions realized by software in the embodiment and the modification may be realized by hardware. A part of functions realized by hardware may be realized by software.

The processing units of the sequence charts of FIGS. 3 and 4 are divided according to main processing contents in order to facilitate understanding of the processing of the processor 51 and the processor 211. The present disclosure is not limited by a way of division and names of the processing units. The processing of the processor 51 and the processor 211 can be divided into a larger number of processing units according to processing contents or can be divided to such that one processing unit includes a large number of kinds of processing. The processing order of the flowcharts is not limited to the illustrated examples.

The control program 55 to be executed by the processor 51 can also be recorded in, for example, a recording medium readable by the projector 1. As the recording medium, a magnetic or optical recording medium or a semiconductor memory device can be used. Specifically, examples of the recording medium include portable or stationary recording media such as a flexible disk, a CD-ROM (Compact Disk Read Only Memory), a DVD, a Blu-ray Disc, a magnetooptical disk, a flash memory, and a card-type recording medium. The control program 55 can be stored in a server device or the like. The display control method can be realized by the projector 1 downloading the control program 55 from the server device. The same applies to the control program 215 to be executed by the processor 211. Blu-ray is a registered trademark.

What is claimed is:

1. An image display method of a display device, the image display method comprising:
displaying a first image based on a first image signal received by wired communication; and
starting displaying a second image based on a second image signal received by wireless communication, when detecting that the first image signal by the wired communication is not received.

2. The image display method of the display device according to claim 1, further comprising, finishing displaying the second image and starting displaying the first image, when the first image signal is received by the wired communication while the second image is displayed.

3. An image display method of a display system, the image display method comprising:
transmitting a first image signal from an interface device to a display device by wired communication, when the interface device is wire-connected to the display device;
displaying, with the display device, a first image based on the first image signal received by the wired communication; and
starting displaying a second image based on a second image signal received by wireless communication, when the display device detects that the first image signal by the wired communication is not received.

4. The image display method of the display system according to claim 3, further comprising transmitting the second image signal from the interface device to the display device by the wireless communication.

5. The image display method of the display system according to claim 4, further comprising receiving a third image signal with the interface device, wherein
the transmitting the first image signal from the interface device to the display device by the wired communication includes transmitting the first image signal based on the third image signal with the interface device, and
the transmitting the second image signal from the interface device to the display device by the wireless communication includes transmitting the second image signal based on the third image signal with the interface device.

6. A display device comprising:
a panel or a lens; and
one or more processors configured to execute:
displaying, with the panel or the lens, a first image based on a first image signal received by wired communication; and
starting displaying a second image based on a second image signal received by wireless communication, when detecting that the first image signal by the wired communication is not received.
